(19) United States
(12) Patent Application Publication
(10) Pub. No.: US 2026/0180322 A1
(43) Pub. Date: Jun. 25, 2026

(54) METHOD FOR CONTROLLING AND PROTECTING AN ELECTRICAL DISTRIBUTION NETWORK FOR AIRCRAFT PROPELLING LOADS

(71) Applicant: SAFRAN ELECTRICAL & POWER, Blagnac (FR)

(72) Inventors: Florence GIRAULT, Moissy-Cramayel (FR); Franck BAQUE, Moissy-Cramayel (FR); Sébastien THOMASSIER, Moissy-Cramayel (FR); Alexis RENOTTE, Moissy-Cramayel (FR)

(73) Assignee: SAFRAN ELECTRICAL & POWER, Blagnac (FR)

(21) Appl. No.: 18/728,817

(22) PCT Filed: Jan. 13, 2023
(86) PCT No.: PCT/FR2023/050049

§ 371 Date: Jul. 12, 2024

(30) Foreign Application Priority Data
Jan. 14, 2022 (FR) 2200329

(51) Int. Cl. H02J 1/12; H02J 1/10

(52) U.S. Cl. CPC H02J 1/12; H02J 1/10

(57) ABSTRACT

A method is presented for controlling and protecting a power distribution system for aircraft propulsion loads including N high-voltage direct current (HVDC) power channels, each bus of rank j being coupled to the bus of rank j+1 by means of a solid-state power controller (SSPC) that is closed in a nominal configuration of the power distribution system. The method includes: detecting a short circuit, reconfiguring the electrical power distribution system to an intermediate degraded configuration in which the SSPCs are open, in response to detecting that the short circuit has occurred on a channel of rank k, non-temporarily opening at least one switching member of the channel of rank k, reconfiguring the distribution system to a final degraded configuration in which at least some of the SSPCs are closed and said at least one switching member of the channel of rank k remains open.

### TECHNICAL FIELD

This disclosure relates to the field of methods for controlling and protecting power distribution systems for aircraft propulsion loads.

### PRIOR ART

Generally speaking, in aeronautics, the equipment and fittings are greatly constrained in terms of mass and of integration capability. To optimize the mass and the integration of the system, the power distribution systems used to power aircraft motors may have what are referred to as distributed architectures.

In this type of architecture, the batteries are connected in parallel to the high-voltage direct current (HVDC) system. In nominal mode, the voltages between the different batteries are balanced so that the batteries supply the different loads in a shared manner. In the event of loss of a battery, the propulsion loads are supplied by the remaining batteries. This allows sizing the batteries as close as possible to nominal operation, and thus to optimize the mass of the batteries. The power distribution system becomes more integrated as well, because the power distribution box associates several loads with several batteries.

One of the difficulties of this type of architecture is the management of faults and in particular of short circuits. In the event of a low-impedance short circuit, for example, a Li-ion battery may deliver a current of several thousand amperes in a few milliseconds. When batteries are connected in parallel in the system, the phenomenon is amplified by the number of parallel batteries, which has two consequences:
The first, a direct consequence, is that the currents involved in this type of short circuit can be destructive to the aeronautical components that exist today on the market, and active protection solutions are not capable of isolating the fault.

The second consequence is tied to the nature of the distributed power distribution architecture. Indeed, unlike a segregated distribution architecture, which does not propagate the consequences of a short circuit to the entire propulsion system, in this type of architecture, the system voltage seen by all the motors will collapse over a period sufficiently long to cause an unacceptable loss of propulsion for the aircraft, all motors linked to the bus no longer receiving power due to the automatic protection linked to a bus voltage level that is too low.

### SUMMARY

The present disclosure improves the situation.

A method is proposed for controlling and protecting a power distribution system for aircraft propulsion loads. The aircraft carries a number N of electrical sources and a number N of propulsion loads. The aircraft also carries the power distribution system.

The power distribution system comprises a number N of high-voltage direct current (HVDC) power channels. Each channel has a rank j between 1 and N. Each channel comprising an input power line, an HVDC distribution bus of rank j, and an output power line. The input power line is connected to the output power line by means of the HVDC distribution bus. Each channel of rank j comprises at least a protection element and a switching member on the input power line and a protection element and a switching member on the output power line.

The input power line is electrically connected to an electrical source and the output power line is electrically connected to a propulsion load.

Each distribution bus of rank j is further coupled to the distribution bus of rank j+1 by means of a solid-state power controller (SSPC) which is closed in a nominal configuration of the power distribution system such that, in the nominal configuration, the electrical power distribution system is able to distribute the electrical power received from the N electrical sources, to the propulsion loads.

The method comprises:
detecting a short circuit in the electrical power distribution system,
reconfiguring the electrical power distribution system to an intermediate degraded configuration in which all the SSPCs are open, so that the channels are electrically isolated from each other,
in response to detecting that the short circuit has occurred on a channel of rank k, non-temporarily opening at least one switching member of the channel of rank k,
reconfiguring the distribution system to a final degraded configuration in which at least the HVDC distribution buses of a rank other than rank k are recoupled together and said at least one switching member of the channel of rank k remains open.

The method is able to be implemented when the aircraft is in flight and on the ground.

This method is particularly advantageous as it makes it possible to transition from a distributed electrical architecture to a temporary segregated electrical architecture while reconfiguring the distributed electrical architecture after isolating the electrical fault.

In particular, the method offers the dual advantage of protecting the components of the electrical system and avoiding the propagation of a failure that could lead to total loss of the propulsion system.

The features set forth in the following paragraphs may optionally be implemented, independently of each other or in combination with each other:
In one embodiment, for each channel of rank j, the input power line is electrically connected to the electrical source by an input connection, and the method further comprises, upon detection that the short circuit has occurred on a channel of rank k, detecting that the short circuit has occurred on the input connection of the channel of rank k. The switching member of the channel of rank k which is open is then the one for the input power line of the channel of rank k. Reconfiguration of the distribution system is then controlled into a first final degraded configuration in which all the SSPCs are closed and the switching member of the input power line of the channel of rank k remains open.

By means of these features, the fault at the input to the electrical source is isolated while retaining the advantages of distribution of the remaining sources to all propulsion loads.

In one embodiment, the method further comprises, in response to detecting that the short circuit has occurred on the channel of rank k, temporarily opening the switching member of the output power line of said channel of rank k, said switching member of the output power line of the channel of rank k being closed in the first final degraded configuration.

By means of these features, the propulsion load of the channel of rank k is disconnected while isolating the electrical fault. Thus, the circuit downstream of the distribution system is protected from the discharge of the propulsion load inverter capacities.

In one embodiment, for each channel of rank j, the output power line is electrically connected to the propulsion load by an output connection. The method further comprises, upon detection that the short circuit has occurred on a channel of rank k, detecting that the short circuit has occurred on the output connection of the channel of rank k. The switching member of the channel of rank k which is open is then the one for the output power line of said channel of rank k. Reconfiguration of the distribution system is then controlled into a second final degraded configuration in which all the SSPCs are closed and said switching member of the output power line of said channel of rank k is open.

By means of these features, the fault in the supply of power to the propulsion load is isolated while retaining the advantages of distribution of the sources to all the remaining propulsion loads.

In one embodiment, the aircraft is carrying a second propulsion load for each channel of rank j, the output power line being a first output power line, the propulsion load being a first propulsion load, the output connection being a first output connection, each channel of rank j further comprising a second output power line connected to the HVDC distribution bus of rank j, the second output power line comprising a protection element and a switching member, the second output power line being electrically connected to the second propulsion load via a second output connection.

By means of these features, two times N propulsion loads may be powered by N electrical sources.

In one embodiment, the method further comprises, upon detection that the short circuit has occurred on said first output connection of the channel of rank k, temporarily opening the switching member of the second output power line of said channel of rank k, said switching member of the second output power line of the channel of rank k being closed in the second final degraded configuration.

By means of these features, the two propulsion loads of the channel are disconnected while isolating the propulsion load at which the electrical fault appeared.

In one embodiment, the distribution system further comprises an inter-bus electrical switch, the HVDC distribution bus of rank 1 and the HVDC distribution bus of rank N being connected via the inter-bus electrical switch which is open in the nominal configuration of the power distribution system.

The method further comprises, upon detection that the short circuit has occurred on a channel of rank k, detecting that the short circuit has occurred on the distribution bus of rank k, the switching member of the channel of rank k which is open is then the one for the input power line of said channel of rank k.

Reconfiguration of the distribution system is then controlled into a third final degraded configuration in which said switching member of the channel of rank k remains open, and
if rank k is equal to 1, all the SSPCs are closed between the HVDC distribution buses of rank 2 to N,
if the rank is equal to N, all the SSPCs are closed between the HVDC distribution buses of rank 1 to N−1,
for all other ranks k, all the SSPCs are closed between the HVDC distribution buses of rank 1 to k-1 and between the buses of rank k+1 to N, and the inter-bus electrical switch is closed.

By means of these features, the system can redistribute electrical energy between the non-isolated channels after isolating the channel of rank k.

In one embodiment, the method further comprises non-temporarily opening the switching member of the output power line of said channel of rank k, said switching member of the output power line remaining open in the third final degraded configuration.

By means of these features, the electrical source and the propulsion load of the faulty channel of rank k are isolated.

In one embodiment, the method further comprises non-temporarily opening the switching member of the second output power line of the channel of rank k, said switching member of the second output power line remaining open in the third final degraded configuration.

By means of these features, the electrical source and the propulsion loads of the faulty channel of rank k are isolated.

A power distribution system comprising a number N of high-voltage direct current (HVDC) power channels is further proposed.

Each channel has a rank j between 1 and N, each channel comprising an input power line, an HVDC distribution bus of rank j, and an output power line. The input power line is connected to the output power line by means of the HVDC distribution bus.

Each channel comprises at least a protection element and a switching member on the input power line and a protection element and a switching member on the output power line.

The input power line is able to be electrically connected to an electrical source and the output power line is able to be electrically connected to one or more propulsion loads.

Each HVDC distribution bus of rank j is further coupled to the HVDC distribution bus of rank j+1 by means of a solid-state power controller (SSPC) which is closed in a nominal configuration of the power distribution system.

Thus, in the nominal configuration, the electrical power distribution system is able to distribute the electrical power received from the N electrical sources, to the propulsion loads.

In the event of a short circuit on a channel of rank k, the electrical power distribution system is further reconfigurable to an intermediate degraded configuration in which the SSPCs are open, so that the channels are electrically isolated from each other.

The electrical power distribution system is also able to open at least one switching member of the channel of rank k.

The electrical power distribution system is further reconfigurable to a final degraded configuration in which at least the HVDC distribution buses of a rank other than rank k are recoupled together and said at least one switching member of the channel of rank k remains open.

According to another aspect, an overall monitoring circuit for the system as described above is proposed, comprising circuit boards configured to execute instructions for implementing all or part of the method as defined above, in particular to control the opening of the SSPCs and switching devices.

### BRIEF DESCRIPTION OF DRAWINGS

Other features, details and advantages will become apparent upon reading the detailed description below, and upon analyzing the attached drawings, in which:

FIG. 1 is a diagram of an example of a reconfigurable power distribution system, in a nominal configuration.

FIG. 2 is a chart of a general method for controlling the system of FIG. 1 in the event of an electrical fault.

FIG. 3 shows the system of FIG. 1 in an intermediate degraded configuration.

FIG. 4 is a diagram of the system of FIG. 1 in which fault zones have been defined.

FIG. 5 is a more detailed chart of the control method of FIG. 5 in which different branches of the method correspond to the different fault zones defined in FIG. 4.

FIG. 6 is a diagram of the system of FIG. 1 in which a fault appears in a first zone.

FIG. 7 is a diagram of the system of FIG. 6, reconfigured to the intermediate degraded configuration.

FIG. 8 is a diagram of the system of FIG. 6, during a subsequent step in the control method of FIG. 5.

FIG. 9 is a diagram of the system of FIG. 6, reconfigured to a first final degraded configuration.

FIG. 10 is a diagram of the system of FIG. 1, in which a fault appears in a second zone.

FIG. 11 is a diagram of the system of FIG. 10, reconfigured to the intermediate degraded configuration.

FIG. 12 is a diagram of the system of FIG. 10 during a subsequent step in the control method of FIG. 5.

FIG. 13 is a diagram of the system of FIG. 10, reconfigured to a second final degraded configuration.

FIG. 14 is a diagram of the system in FIG. 1 in which a fault appears in a third zone.

FIG. 15 is a diagram of the system of FIG. 14, reconfigured to the intermediate degraded configuration.

FIG. 16 is a diagram of the system of FIG. 14 during a subsequent step in the control method of FIG. 5.

FIG. 17 is a diagram of the system of FIG. 14, reconfigured to a third final degraded configuration.

In the remainder of the description and to simplify the illustration, any electrical connection in the open position will be represented by a rectangle containing an X, while the same element in the closed position will be represented by the rectangle alone.

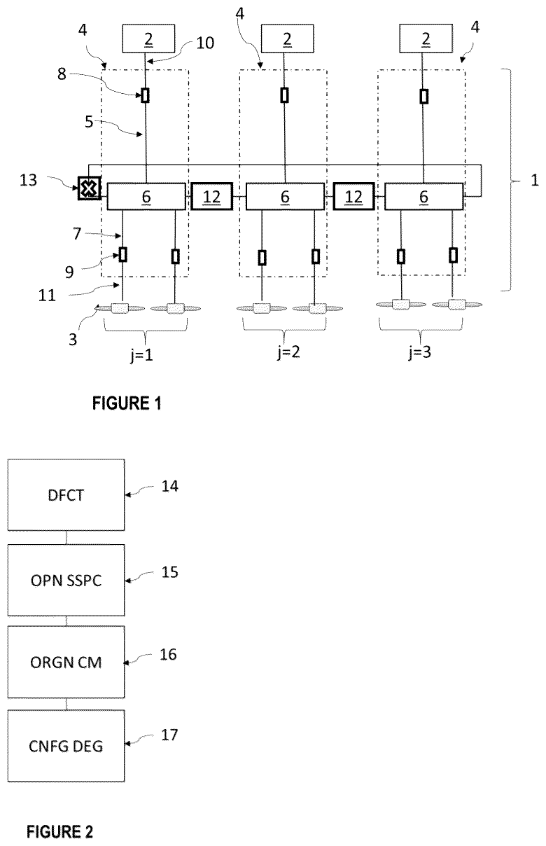

Reference is now made to FIG. 1. A propulsion system for an aircraft comprises a power distribution system 1, a set of electrical sources 2, and a set of propulsion loads 3. Propulsion loads 3 are electric motors.

FIG. 1 represents such a power distribution system 1 in which the aim is to efficiently distribute electrical energy from set of electrical sources 2 to set of propulsion loads 3 in an aircraft in flight, for example an airplane.

System 1 is shown in a nominal configuration. Nominal configuration is understood to mean a normal configuration, when there is no electrical fault, such as a short circuit, during a flight of the aircraft.

For illustrative purposes, system 1 has a number N=3 of channels 4 and two propulsion loads 3 per channel 4. It is apparent that the description of system 1 may be adapted to any number N of channels 4.

Channels 4 are high-voltage direct current (HVDC) power channels.

As illustrated, each channel 4 has a rank j, where j may be equal to 1, 2 or 3. Each channel 4 comprises an input power line 5, a distribution bus 6 of rank j, and two output power lines 7. Distribution bus 6 is an HVDC bus. Input power line 5 is connected to the two output power lines 7 via distribution bus 6.

Each channel 4 comprises a switching member 8 on input power line 5 and a switching member 9 on each of the two output power lines 7. Switching members 8, 9 are bipolar switching members which make it possible to ensure galvanic isolation and the respective line connections of electrical sources 2 and propulsion loads 3.

Each channel 4 is connected to one of electrical sources 2 via an input connection 10. Input power line 5 is electrically connected to input connection 10 which carries electrical power from electrical source 2 to channel 4.

Each channel 4 is respectively connected to two propulsion loads 3 via two respective output connections 11. The two output connections 11 are both electrically connected to distribution bus 6 by the two output power lines 7.

Distribution bus 6 of channel 4 of rank j=1 is connected to distribution bus 6 of channel 4 of rank j=2 via a solid-state power controller (SSPC) 12.

As can be seen in FIG. 1, SSPC 12 is closed in the nominal configuration of system 1.

Distribution bus 6 of channel 4 of rank j=2 is also connected to distribution bus 6 of channel 4 of rank j=3 via a solid-state power controller (SSPC) 12, also closed.

Thus, channels 4 are interconnected via their distribution bus 6. In other words, channels 4 are parallel. Thus, in a nominal configuration, system 1 is able to distribute the electrical power received from all electrical sources 2, to propulsion loads 3.

As one can see, distribution bus 6 of channel 4 of rank j=1 is also connected to distribution bus 6 of channel 4 of rank j=3 via an inter-bus electrical switch 13, which is open. The role of inter-bus electrical switch 13 is to reconnect channels 1 and 3 in the event of a loss of the bus of rank j=2.

System 1 is a system that may be reconfigured under the action of an overall monitoring circuit comprising several circuit boards (not shown). The overall monitoring circuit further comprises open commands for SSPCs 12, for inter-bus electrical switch 13, and for switching members 8 and 9. The overall monitoring circuit further comprises current and voltage sensors. SSPCs 12 also have their own current measurement.

The control method implemented for the management of short circuits is described with reference to FIG. 2.

In a first step 14, the monitoring circuit is able to detect a short circuit in one of channels 4 of rank j=k. System 1 is then in a nominal configuration.

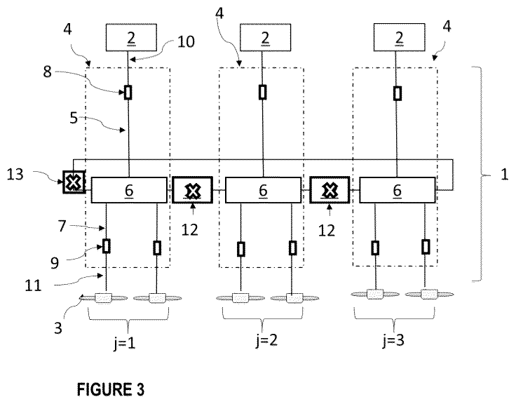

In a second step 15, the monitoring circuit then controls system 1 to reconfigure it to an intermediate degraded configuration in which SSPCs 12 are open. The intermediate degraded configuration of system 1 is represented with reference to FIG. 3 where SSPCs 12 are represented by a rectangle containing an X.

SSPCs 12 isolate the different channels 4 in about ten microseconds. Thus, in the intermediate degraded configuration, channels 4 are electrically isolated from each other. In other words, the propulsion system then becomes segregated, which will allow locating and clarifying the fault in channel 4 of rank j=k affected by the failure without impacting the other channels 4.

Advantageously, the overall undervoltage caused by the short circuit lasts only the few microseconds corresponding to the time for SSPC 12 to open. As soon as SSPCs 12 are open, the system becomes segregated, and the lines unaffected by the fault see their voltage return to a normal level, which allows keeping propulsion loads 3 operational.

Thus, the very short electrical transient is not perceived in the aerodynamic torque from propulsion load 3: as the electrical protection for propulsion load 3 receiving the low voltage is slower than the opening of SSPC 12, this should not cause propulsion load 3 to fail.

Furthermore, advantageously, the current seen by the components at faulty channel 4 remains the current from a single battery and not the current from the batteries 3 connected in parallel.

In a third step 16, a switching member of the channel of rank k is opened so as to isolate the corresponding electrical fault.

Once the fault is isolated, in a fourth step 17, SSPCs 12 are closed so that system 1 is reconfigured to a final degraded configuration, in which the fault is isolated but the distribution properties of system 1 are preserved.

Thus, once the faulty power line is isolated, it is possible to reconnect distribution buses 6 in order to restore the parallel reconnection of electrical sources 2, after analyzing system 1 and locating the fault.

This reconnection is achieved either by closing SSPCs 12, or by closing inter-bus electrical switch 13 if the fault is at the distribution bus of rank k=2.

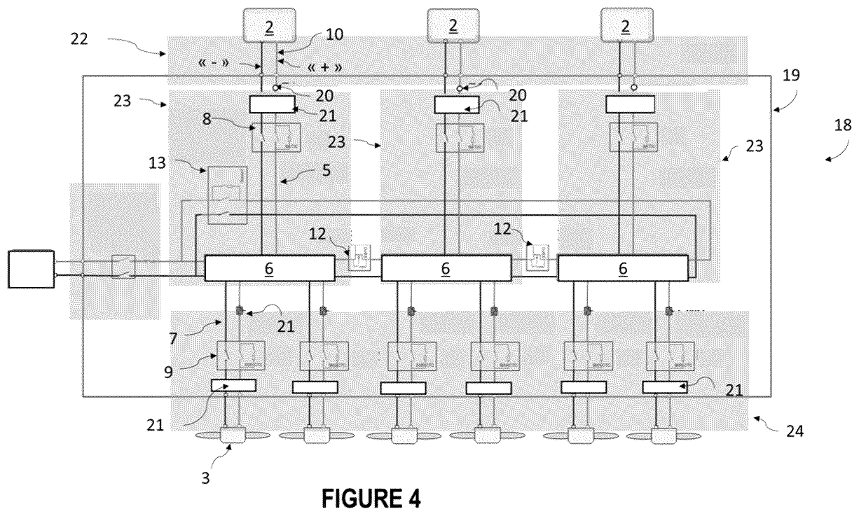

Different mechanisms are involved in this method, depending on the areas of the propulsion system affected by the electrical fault. The different zones are represented with reference to FIG. 4, which represents a propulsion system 18 comprising a protective housing 19 in which system 1 is integrated. Elements identical to those presented with reference to FIG. 1 are identified by the same reference numbers.

FIG. 4 provides an additional level of detail. In particular, the “+” poles and “−” poles of each power line are represented.

In particular, one can see that each input power line 5 is protected by a protection element 20. Protection element 20 is a fuse.

In particular, one can see that each output power line 7 is protected by a protection element 21. Protection element 21 is a pyroswitch fuse.

There are also current and voltage sensors 21 on each of input power lines 5 and each of output power lines 7, ensuring the management and protection of the entire system 1.

For each zone of the propulsion system, implementation of the third step 16 and fourth step 17 of the control method is an implementation specific to the zone in which the electrical fault appears.

First zone 22 comprises the electrical sources 2 and input connections 10 connected to all channels 4. First zone 22 is located between electrical sources 2 and protective housing 19.

Second zone 23 comprises all output power lines 7 of all channels 4. Second zone 23 is located between protective housing 19 and propulsion loads 3.

The three third zones 24, each belonging to a channel 4 of rank j, each respectively comprise input power line 5 and distribution bus 6 of channel 4. Third zones 24 are located within protective housing 19 and concern faults internal to protective housing 19.

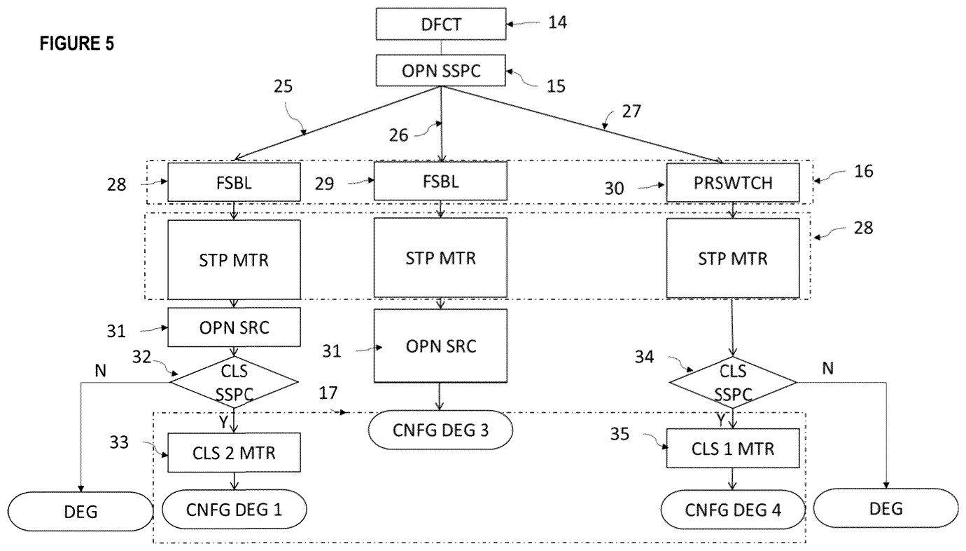

FIG. 5 represents the three different branches 25, 26 and 27 of the implementation of the control method, depending on the zone where the short circuit is located, respectively first zone 22, second zone 23, or one of third zones 24. For the purposes of the description, let us consider a fault that appears in channel 4 of rank j=k.

For branch 25 corresponding to a short circuit appearing in first zone 22, third step 16 of the method is a specific step 28. Specific step 28 comprises opening the fuse of electrical source 2 connected to channel 4 of rank k in which the short circuit appeared. In other words, the fuse in the faulty wiring trips.

For branch 26 corresponding to a short circuit which appears in one of third zones 24, third step 16 of the method is a specific step 29. Specific step 29 comprises opening protection element 20 of input power line 5 of channel 4 of rank j=k in which the short circuit appeared. In other words, the fuse in the faulty wiring trips.

For branch 27 corresponding to a short circuit which appears in second zone 23, third step 16 of the method is a specific step 30. Specific step 30 comprises opening protection element 21 of output power line 7 of channel 4 of rank j=k in which the short circuit appeared. In other words, the fuse in the faulty wiring trips.

Then, in a step 31 common to the three branches 25, 26 and 27, for channel 4 of rank j=k in which the short circuit appeared, the overall monitoring circuit then controls the opening of the two switching members 9 of the two output power lines 7. In other words, the overall monitoring circuit requests shutdown of the propulsion loads associated with the bus of rank j=k.

When the fault is located between an electrical source 2 and protective housing 16, meaning for branch 25, a specific step 31 is implemented in which the overall monitoring circuit then controls the opening of switching member 8 of input power line 5. In other words, the overall monitoring circuit isolates electrical source 2 associated with the bus of rank j=k.

Then, the overall monitoring circuit checks, in a step 32, whether to authorize the closing of SSPCs 12. If so, in a step 33, the pre-charge lines are closed and the overall monitoring circuit then orders the closing of the two switching members 9 of the two output power lines 7. In other words, the overall monitoring circuit restarts the propulsion loads associated with the bus of rank j=k.

The flight mission of the aircraft then continues with a system 1 in a first final degraded configuration, in which SSPCs 12 are closed and switching member 8 of input power line 5 of channel 4 of rank j=k remains open. In other words, two electrical sources power the six propulsion loads.

In one advantageous option, in step 32, if the overall monitoring circuit does not authorize the closing of SSPCs 12, then the flight mission of the aircraft continues by reconnecting the distribution buses of the two channels 4 not affected by faults. In this case, two electrical sources 2 supply power to four propulsion loads 3, and the faulty channel 4 of rank j=k is not reconnected.

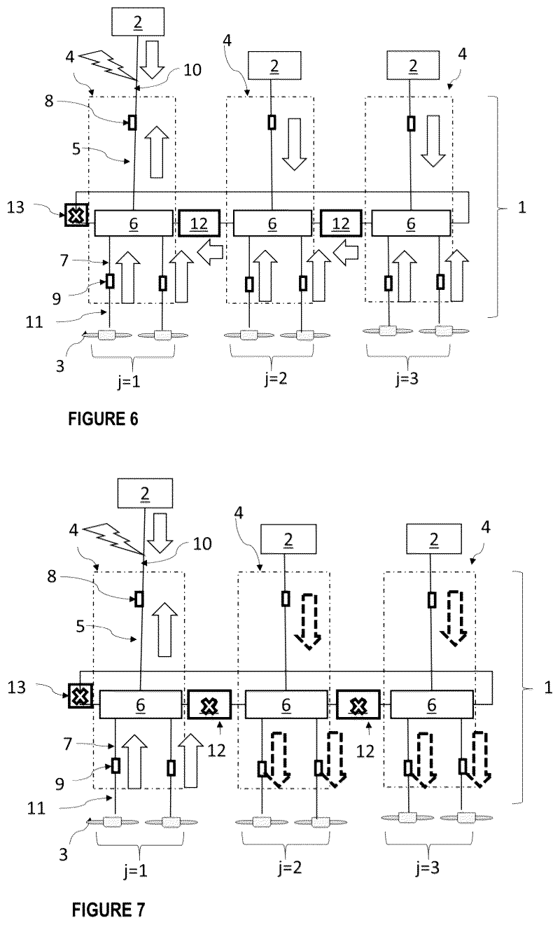

One example implementation of the control method when the fault is located between an electrical source 2 and protective housing 16 is described with reference to FIGS. 6 to 9.

FIG. 6 represents the propulsion system 18 of FIG. 1, when a fault appears on input connection 10 of the channel of rank j=1. In other words, in this example, faulty rank k of channel 4 is rank 1. In general, the fault may occur on the other two channels 4: in other words, rank j=k could take the value j=2 or the value j=3. The fault is represented by a lightning bolt and the flow of electrical currents that are abnormal in direction and intensity is represented by arrows drawn with solid lines.

During the first microseconds, the three electrical sources 2 and the propulsion loads 3 will deliver electric current into the fault, with a strong variation in intensity over time.

This current flow will very quickly cause isolation of the channels 4 from each other via the two SSPCs 12, which is illustrated in FIG. 7. In FIG. 7, one can see normal flows of electric current represented by arrows drawn with dotted lines, on channels of rank j=2 and j=3. As shown, both SSPCs 12 are open.

The configuration of system 1 is then in the intermediate degraded configuration where SSPCs 12 are open, so that channels 4 are electrically isolated from each other.

Thus, the two propulsion loads 3 linked to distribution bus 6 of rank j=2 and to distribution bus 6 of rank j=3 remain operational.

Indeed, the fault is isolated faster than the propulsion loads 3 enter a fault condition. Therefore, the dynamics of the motors should not generate a significant loss of thrust in the aircraft.

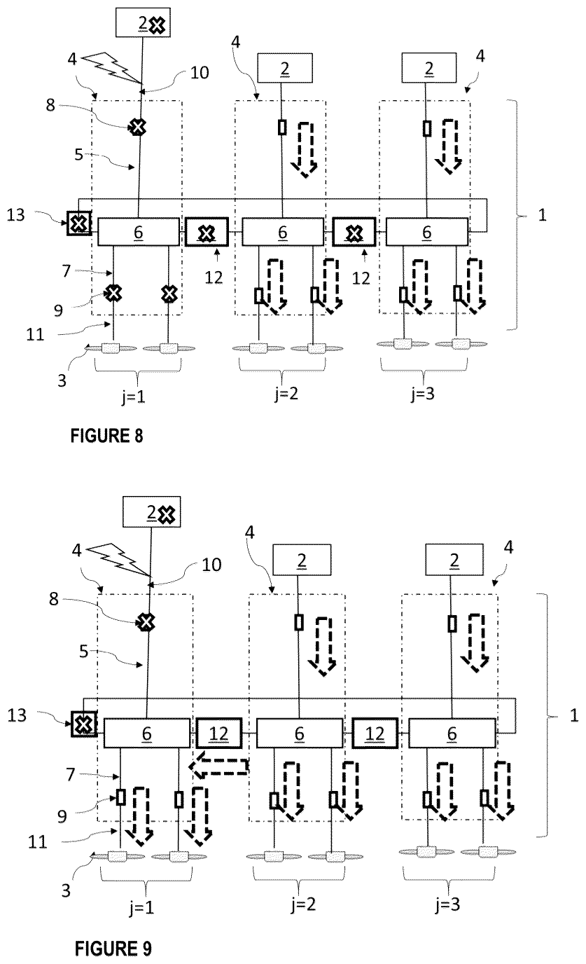

However, the overall monitoring circuit requires stopping propulsion loads 3 associated with the distribution bus of rank k=1, as shown in FIG. 8. Indeed, during the fault, the motor inverter capacities will have discharged into the fault, so the motors are placed under undervoltage protection.

The internal protection device of electrical source 2 will also isolate a fault of the voltage source, which cannot be stopped intrinsically.

Once the current has dropped to an acceptable level, switching member 8 of the channel of rank k=1 is controlled to open in order to isolate the short circuit zone galvanically.

In order to properly restart propulsion loads 3, the two switching members of the channel of rank k=1 are controlled to open. Protection elements 21 of the channel of rank k=1 do not isolate propulsion loads 3 during this operation, because they are unidirectional in their protection and their function is to protect the circuit downstream of system 1.

Once the fault is isolated, the overall monitoring circuit can reconfigure system 1 to the first final degraded configuration.

More precisely, the overall monitoring circuit orders the closing of the two SSPCs 12 by using the internal pre-charge function of the SSPCs 12, based on the state of electrical sources 2. An additional lock may be implemented here in order to be certain that the fault zone has indeed been identified in first zone 22 and that the fault is not in third zone 24 of the channel of rank k=1: If pre-charge of distribution bus 6 of rank k=1 does not occur within a given maximum time, distribution bus 6 of rank k=1 is considered to be faulty and can no longer be resupplied with power.

Once the two SSPCs 12 are closed, switching members 9 of propulsion loads 3 of channel 4 of rank k=1 may be closed, also using the associated pre-charge. Propulsion loads 3 may thus be restarted upon instruction from the overall monitoring circuit.

The final configuration of the system for finishing the aircraft mission is shown in FIG. 9: the two remaining electrical sources 2 power all the propulsion loads 3.

For branch 27 of FIG. 5, the fault is located between protective housing 16 and propulsion loads 3, on channel 4 of rank j=k. In this case, there is no step 31. The overall monitoring circuit checks directly in a step 34 whether to authorize the closing of SSPCs 12.

If so, in step 35, the pre-charge lines are closed. The overall monitoring circuit then controls the closing of switching member 9 of healthy output power line 7. In other words, the overall monitoring circuit restarts propulsion load 3 not affected by a fault associated with the bus of rank k. On the other hand, the other propulsion load 3 associated with the bus of rank k remains isolated.

The flight mission of the aircraft then continues with a system 1 in a second final degraded configuration, in which SSPCs 12 are closed and switching member 9 of one of the two output power lines 7 of channel 4 of rank k remains open. In other words, three electrical sources power five propulsion loads 3.

In an advantageous option, if the overall monitoring circuit does not authorize the closing of SSPCs 12 in step 34, then the flight mission of the aircraft continues by reconnecting the distribution buses of the two channels 4 not affected by the fault. In this case, two electrical sources 2 power four propulsion loads 3, and faulty channel 4 is not reconnected.

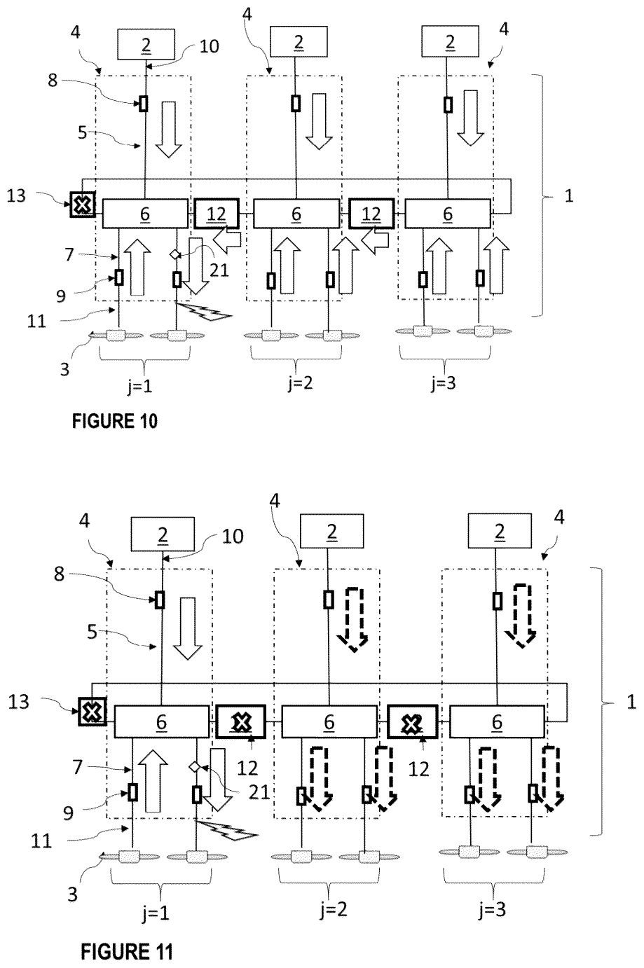

One example implementation of the control method when the fault is located between protective housing 16 and propulsion loads 3 is described with reference to FIGS. 10 to 13.

As can be seen in FIG. 10, an electrical fault represented by a lightning bolt appears on the second output connection 11 of channel 4 of rank j=k=1.

In order to isolate electrical source 2 from faulty channel 4 of rank 1, the two SSPCs 12 then open, as shown in FIG. 11 corresponding to an intermediate degraded configuration of system 1.

In order to isolate the fault from distribution bus 6 of channel 4 of rank 1, protection element 21 of second output connection 11 will isolate the fault present in the wiring of second propulsion load 3.

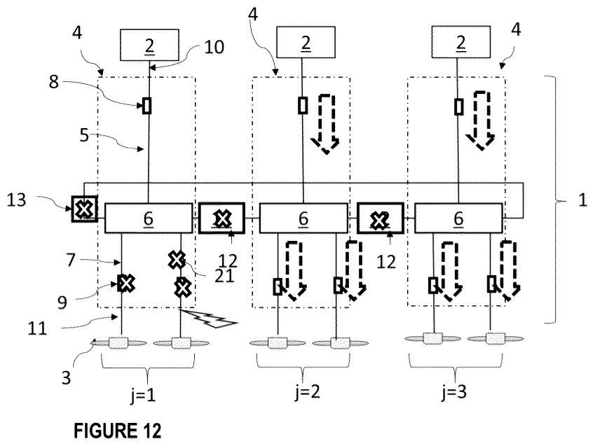

In order to disconnect the motors from faulty channel 4 of rank 1, the overall monitoring circuit sends a request to stop propulsion loads 3 linked to distribution bus 6 of rank 1. The two switching members 9 are then opened. The corresponding configuration of system is shown with reference to FIG. 12.

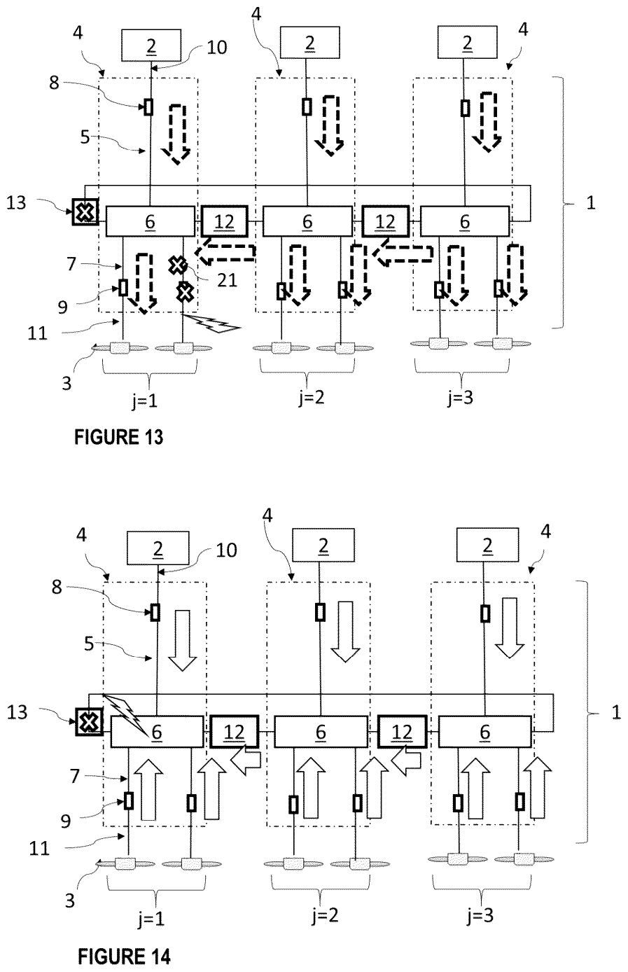

The overall monitoring circuit then orders the reconfiguration of system 1 to the second final degraded configuration shown in FIG. 13.

In effect, the two SSPCs 12 are closed in order to return system 1 to the distributed configuration. In addition, first propulsion load 3 which is not on the faulty line may be brought back online depending on the needs of the aircraft, by closing the corresponding switching member 9.

For branch 26 of the control method in FIG. 5, the fault corresponds to one of third zones 24. A specific step 31 identical to that of branch 25 is implemented. This corresponds to the case where distribution bus 6 of rank k is faulty. The overall monitoring circuit then isolates electrical source 2 associated with the bus of rank k.

The flight mission of the aircraft then continues with a system 1 in a third final degraded configuration, in which switching members 8 and 9 of channel 4 of rank k remain open and:
if rank k is equal to 1, SSPC 12 is closed between the distribution bus of rank 2 and the distribution bus of rank 3,
if rank k is equal to 3, SSPC 12 is closed between the distribution bus of rank 1 and the distribution bus of rank 2,
if rank k is equal to 2, the inter-bus electrical switch 13 is closed and the two SSPCs 12 remain open.

One example implementation of the control method when the fault is located on a distribution bus 6 is described with reference to FIGS. 14 to 17.

As can be seen in FIG. 14, an electrical fault represented by a lightning bolt appears on distribution bus 6 of rank j=k=1.

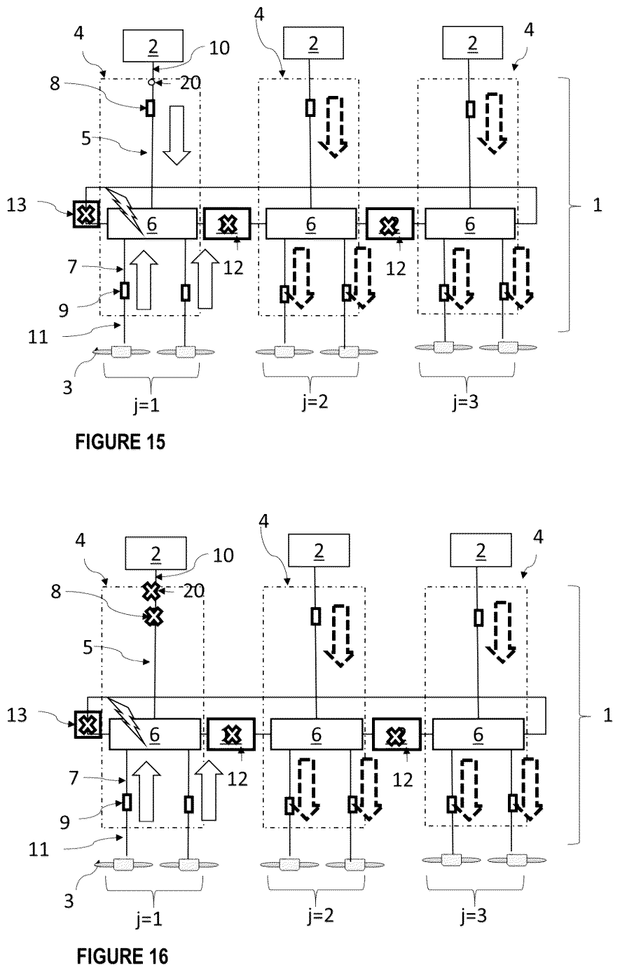

Initially, the overall monitoring circuit orders the isolation of the channels 4 from each other so as to place system 1 in an intermediate degraded configuration shown in FIG. 15. As in the above cases, the two SSPCs 12 will therefore open.

On channel 4 of rank 1, in order to isolate electrical source 2, protection element 20 of input power line 5 will trip, as shown in FIG. 16. The internal protection element of electrical source 2 may also participate in the electrical isolation, depending on its design.

On channel 4 of rank 1, once the electric current has dropped to an acceptable level, switching member 8 is ordered to open in order to isolate the short circuit zone from electrical source 2.

The configuration of system 1 after this step is shown in FIG. 16.

Then, in order to disconnect the motors from faulty channel 4 of rank 1, the overall monitoring circuit requires stopping the two propulsion loads 3 associated with distribution bus 6.

Once the current has dropped to an acceptable level, the two switching members 9 will be ordered to open in order to isolate the short circuit zone, so as to avoid any regeneration of the electric motors in the fault, for example such as windmilling with the aerodynamic thrust of the blades.

With protection element 20 of input power line 5 being isolated first, the fault is located in third zone 24 corresponding to first channel 4 of rank 1. The system logic then prohibits reclosing the first SSPC 12 between first channel 4 of rank 1 and second channel 4 of rank 2. As for the second SSPC 12, it may be closed so as to reconnect second channel 4 of rank 2 with third channel 4 of rank 3.

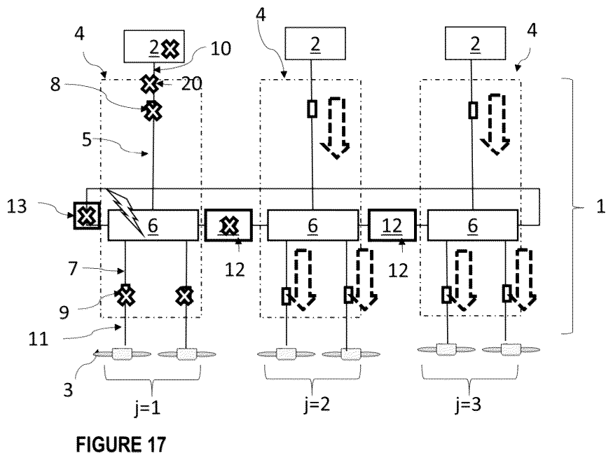

The configuration of system 1 for completion of the mission is described in FIG. 17, corresponding to the third final degraded configuration.

In this fault case, the two faulty motors of channel 4 of rank k=1 are irreversibly lost. In other words, two electrical sources 2 power four propulsion loads 3 and one channel remains isolated and lost.

1. A method for controlling and protecting a power distribution system for propulsion loads of an aircraft,
the aircraft carrying a number N of electrical sources and a number N of propulsion loads, the aircraft also carrying the power distribution system,
the power distribution system comprising a number N of high-voltage direct current (HVDC) power channels,
each HVDC power channel having a rank j between 1 and N, each HVDC power channel comprising an input power line, an HVDC distribution bus of rank j, and an output power line, the input power line being connected to the output power line by the HVDC distribution bus, each HVDC power channel of rank j comprising at least a protection element and a switching member on the input power line and a protection element and a switching member on the output power line,
the input power line being electrically connected to an electrical source and the output power line being electrically connected to a propulsion load,
each distribution bus of rank j further being coupled to the distribution bus of rank j+1 by means of a solid-state power controller (SSPC) which is closed in a nominal configuration of the power distribution system,
such that, in the nominal configuration, the electrical power distribution system is able to distribute the electrical power received from the N electrical sources, to the propulsion loads,
the method comprising:
detecting a short circuit in the electrical power distribution system;
reconfiguring the electrical power distribution system to an intermediate degraded configuration in which all the SSPCs are open, so that the HVDC power channels are electrically isolated from each other;
in response to detecting that the short circuit has occurred on a HVDC power channel of rank k, non-temporarily opening at least one switching member of the HVDC power channel of rank k; and
reconfiguring the distribution system to a final degraded configuration in which at least the HVDC distribution buses of a rank other than rank k are recoupled together and the at least one switching member of the HVDC power channel of rank k remains open.

2. The method of claim 1, wherein, for each HVDC power channel of rank j, the input power line is electrically connected to the electrical source by an input connection,
wherein the method further comprises, upon detection that the short circuit has occurred on a HVDC power channel of rank k, detecting that the short circuit has occurred on the input connection of the HVDC power channel of rank k,
wherein the switching member of the HVDC power channel of rank k which is open is then the one for the input power line of the HVDC power channel of rank k, and
wherein reconfiguration of the distribution system is then controlled into a first final degraded configuration in which all the SSPCs are closed and the switching member of the input power line of the HVDC power channel of rank k is open.

3. The method of claim 2, further comprising in response to detecting that the short circuit has occurred on the HVDC power channel of rank k, temporarily opening the switching member of the output power line of the HVDC power channel of rank k,
wherein the switching member of the output power line of the HVDC power channel of rank k is closed in the first final degraded configuration.

4. The method of claim 1, wherein, for each HVDC power channel of rank j, the output power line is electrically connected to the propulsion load by an output connection,
wherein the method further comprises, upon detection that the short circuit has occurred on the HVDC power channel of rank k, detecting that the short circuit has occurred on the output connection of the HVDC power channel of rank k,
wherein the switching member of the HVDC power channel of rank k which is open is then the one for the output power line of the HVDC power channel of rank k, and
wherein reconfiguration of the distribution system is then controlled into a second final degraded configuration in which all the SSPCs are closed and the switching member of the output power line of the HVDC power channel of rank k is open.

5. The method of claim 1, wherein the aircraft is carrying a second propulsion load for each HVDC power channel of rank j, the output power line being a first output power line, the propulsion load being a first propulsion load, the output connection being a first output connection, and
wherein each HVDC power channel of rank j further comprising a second output power line connected to the HVDC distribution bus of rank j, the second output power line comprising a protection element and a switching member, the second output power line being electrically connected to the second propulsion load by a second output connection.

6. The method of claim 5, further comprising, upon detection that the short circuit has occurred on the first output connection of the HVDC power channel of rank k, temporarily opening the switching member of the second output power line of the HVDC power channel of rank k,
wherein the switching member of the second output power line of the HVDC power channel of rank k being closed in the second final degraded configuration.

7. The method of claim 1, wherein the distribution system further comprises an inter-bus electrical switch, the HVDC distribution bus of rank 1 and the HVDC distribution bus of rank N being connected via the inter-bus electrical switch which is open in the nominal configuration of the power distribution system,
wherein the method further comprises, upon detection that the short circuit has occurred on the HVDC power channel of rank k, detecting that the short circuit has occurred on the HVDC distribution bus of rank k,
wherein the switching member of the HVDC power channel of rank k which is open is then the one for the input power line of the HVDC power channel of rank k,
wherein reconfiguration of the distribution system is then controlled into a third final degraded configuration in which the switching member of the HVDC power channel of rank k remains open, and:
if rank k is equal to 1, all the SSPCs are closed between the HVDC distribution buses of rank 2 to N;
if the rank is equal to N, all the SSPCs are closed between the HVDC distribution buses of rank 1 to N−1; and
for all other ranks k, all the SSPCs are closed between the HVDC distribution buses of rank 1 to k−1 and between the buses of rank k+1 to N, and the inter-bus electrical switch is closed.

8. to The method of claim 7, further comprising non-temporarily opening the switching member of the output power line of the HVDC power channel of rank k, the switching member of the output power line remaining open in the third final degraded configuration.

9. The method of claim 7, further comprising non-temporarily opening the switching member of the second output power line of the HVDC power channel of rank k, the switching member of the second output power line remaining open in the third final degraded configuration.

10. A power distribution system, comprising a number N of high-voltage direct current (HVDC) power channels,
each HVDC power channel having a rank j between 1 and N, each HVDC power channel comprising an input power line, an HVDC distribution bus of rank j, and an output power line, the input power line being connected to the output power line by the HVDC distribution bus, each HVDC power channel of rank j comprising at least a protection element and a switching member on the input power line and a protection element and a switching member on the output power line,
the input power line configured to be electrically connected to an electrical source and the output power line configured to be electrically connected to a propulsion load,
wherein each HVDC distribution bus of rank j is further coupled to the HVDC distribution bus of rank j+1 by means of a solid-state power controller (SSPC) which is closed in a nominal configuration of the power distribution system, such that, in the nominal configuration, the electrical power distribution system is able to distribute the electrical power received from the N electrical sources, to the propulsion loads,
the electrical power distribution system further being reconfigurable, in the event of a short circuit on a HVDC power channel of rank k, to an intermediate degraded configuration in which all the SSPCs are open, so that the HVDC power channels are electrically isolated from each other,
the electrical power distribution system further configured to open at least one switching member of the HVDC power channel of rank k, and
the electrical power distribution system further being reconfigurable to a final degraded configuration in which at least the HVDC distribution buses of a rank other than rank k are recoupled together and the at least one switching member of the HVDC power channel of rank k remains open.
